(19) United States
(12) Patent Application Publication
(10) Pub. No.: US 2014/0226953 A1
(43) Pub. Date: Aug. 14, 2014

(54) FACILITATING USER INPUT DURING PLAYBACK OF CONTENT

(71) Applicant: RPLY, INC., Austin, TX (US)

(72) Inventor: Taylor Hou, Missouri City, TX (US)

(73) Assignee: RPLY, INC., Austin, TX (US)

(21) Appl. No.: 13/766,882

(22) Filed: Feb. 14, 2013

(51) Int. Cl. H04N 9/87

(52) U.S. Cl. CPC H04N 9/87
USPC 386/230; 386/349

(57) ABSTRACT

The disclosed embodiments provide a system that provides content to a user. During playback of the content, the system enables input associated with the content from the user. Upon detecting initiation of the input by the user, the system automatically pauses the playback without receiving a request to pause the content or provide the input from the user.

### BACKGROUND

1. Field

The disclosure relates to use of content by users. More specifically, the disclosure relates to techniques for facilitating user input associated with the content during playback of the content.

2. Related Art

Production of content such as video and/or audio is typically a collaborative process, in which multiple users involved in creation of the content decide on the selection, creation, arrangement, editing, and/or delivery of the content. To facilitate such decisions, the users may use a variety of communications and/or playback mechanisms to access and/or provide input regarding the content. For example, the users may share and/or access the content using a video and/or audio hosting service and provide feedback, comments, and/or other input related to the content through the hosting service and/or email, phone, and/or in-person communications.

Unfortunately, conventional techniques for collaborating on production of content may be tedious and/or time-consuming. For example, a set of users may view a video through a video hosting service and/or video editing application and provide feedback on the video through email, physical notes, text documents, and/or audio recordings. As a result, each user may be required to manually switch between a mechanism for viewing the video and a mechanism for providing the feedback. The user may also be required to manually identify and/or note relevant attributes of the video, such as timestamps and/or regions of frames, within the feedback.

Alternatively, the users may simplify sharing of the feedback by providing the feedback as comments, likes, dislikes, and/or other input to the video hosting service and/or video editing application. However, the process of inputting the comments may involve manual configuration of video playback from the users, including pausing the playback before inputting a comment, resuming the playback after the comment is submitted, and/or rewinding the content if the comment is inputted while the content is playing.

Consequently, collaboration on production of content may be facilitated by mechanisms for reducing overhead associated with providing user feedback and/or input related to the content.

### SUMMARY

The disclosed embodiments provide a system that provides content to a user. During playback of the content, the system enables input associated with the content from the user. Upon detecting initiation of the input by the user, the system automatically pauses the playback without receiving a request to pause the content or provide the input from the user.

In one or more embodiments, the system also automatically resumes the playback after the input has not been received for a pre-specified period.

In one or more embodiments, the system also resumes the playback after the input is submitted by the user.

In one or more embodiments, during providing of the input by the user, the system also displays the input within an overlay associated with the content.

In one or more embodiments, displaying the input as the overlay associated with the content involves repositioning the overlay based on the input.

In one or more embodiments, the system also displays graphical representations of the user and one or more other users along a progress bar associated with the playback.

In one or more embodiments, the input includes at least one of:

(i) selection of an input field associated with the input;

(ii) use of an input device;

(iii) audio input;

(iv) a gesture;

(v) a facial expression; and

(vi) an eye movement.

### BRIEF DESCRIPTION OF THE DRAWINGS

FIG. 1 shows a schematic of a system in accordance with one or more embodiments.

FIG. 2A shows an exemplary screenshot in accordance with one or more embodiments.

FIG. 2B shows an exemplary screenshot in accordance with one or more embodiments.

FIG. 3 shows a flowchart illustrating the process of providing content to a user in accordance with one or more embodiments.

FIG. 4 shows a computer system in accordance with one or more embodiments.

In the figures, like elements are denoted by like reference numerals.

### DETAILED DESCRIPTION

In the following detailed description, numerous specific details are set forth to provide a thorough understanding of the disclosed embodiments. However, it will be apparent to those skilled in the art that the disclosed embodiments may be practiced without these specific details. In other instances, well-known features have not been described in detail to avoid unnecessarily complicating the description.

Methods, structures, apparatuses, modules, and/or other components described herein may be enabled and operated using hardware circuitry, including but not limited to transistors, logic gates, and/or electrical circuits such as application-specific integrated circuits (ASICs), field-programmable gate arrays (FPGAs), digital signal processors (DSPs), and/or other dedicated or shared processors now known or later developed. Such components may also be provided using firmware, software, and/or a combination of hardware, firmware, and/or software.

The operations, methods, and processes disclosed herein may be embodied as code and/or data, which may be stored on a non-transitory computer-readable storage medium for use by a computer system. The computer-readable storage medium may correspond to volatile memory, non-volatile memory, hard disk drives (HDDs), solid-state drives (SSDs), hybrid disk drives (HDDs), magnetic tape, compact discs (CDs), digital video discs (DVDs), and/or other media capable of storing code and/or data now known or later developed. When the computer system reads and executes the code and/or data stored on the computer-readable storage medium, the computer system performs the methods and processes embodied in the code and/or data.

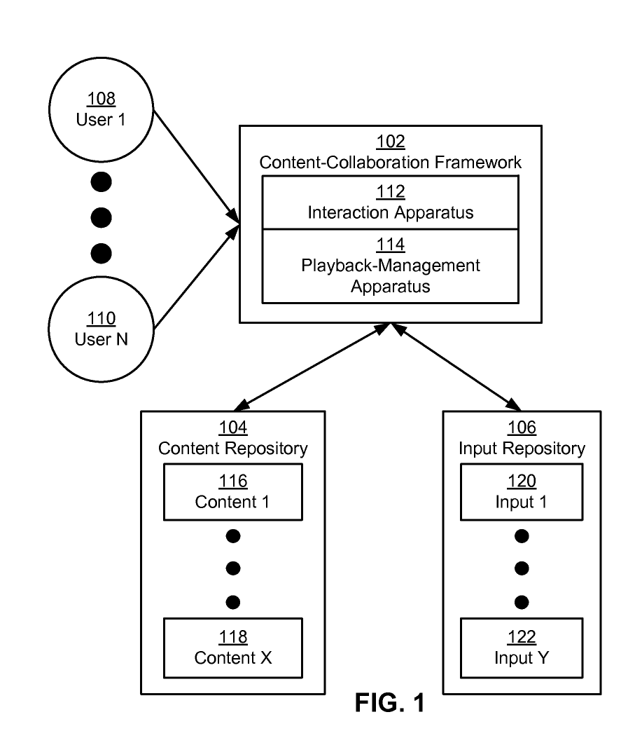

The disclosed embodiments relate to a method and system for facilitating user input during playback of content such as audio and/or video. As shown in FIG. 1, the system may be provided by a content-collaboration framework 102 that may be accessed by a set of users (e.g., user 1 108, user n 110) during collaboration on creation and/or production of the content.

Content-collaboration framework 102 may be implemented using a client-server architecture. For example, content-collaboration framework 102 may run on one or more servers and provide services through a web browser and network connection. Conversely, content-collaboration framework 102 may be accessed through a locally installed client application on one or more network-enabled electronic devices associated with the users, such as personal computers, laptop computers, mobile phones, portable media players, tablet computers, and/or personal digital assistants. In other words, content-collaboration framework 102 may be implemented using a cloud computing system that is accessed over the Internet and/or one or more other computer networks. Regardless of the method of access, use of content-collaboration framework 102 may be facilitated by a user interface, such as a graphical user interface (GUI) and/or web-based user interface.

During use of content-collaboration framework 102, each user may upload content (e.g., content 1 116, content x 118) to content-collaboration framework 102, share the uploaded content with other users involved in creation of the content, and/or provide input (e.g., input 1 120, input y 122) associated with the content. For example, the user may use a network connection to transmit digital recordings of audio and/or video to content-collaboration framework 102, and content-collaboration framework 102 may persist the transmitted recordings in a relational database, filesystem, and/or other type of content repository 104. After the recordings are uploaded, the user may invite one or more other users collaborating on editing and/or production of the recordings to view the recordings through content-collaboration framework 102. The user and/or other users may also leave comments, notes, ratings, likes, dislikes, and/or other feedback for the recordings during and/or after playback of the recordings through content-collaboration framework 102. The user and/or other users may then use the feedback to iteratively update, edit, and/or otherwise modify the recordings into a finished audio and/or video product.

More specifically, a playback-management apparatus 114 in content-collaboration framework may manage playback of the content to the users, and an interaction apparatus 112 in content-collaboration framework 102 may manage input associated with the content from the users during the playback. Playback-management apparatus 114 may enable the playback by retrieving the content from content repository 104 and streaming the content over a network connection to one or more electronic devices of the users. Playback-management apparatus 114 may also enable the use of buttons, keyboard shortcuts, verbal commands, gestures, and/or other mechanisms by the users to pause, stop, rewind, fast-forward, speed up, and/or slow the playback. Playback-management apparatus 114 may further include an option to load and/or store a copy of the content on the electronic device(s) before, during, and/or after the playback to facilitate subsequent access to and/or modification of the content by the users. For example, playback-management apparatus 114 may allow the users to transfer audio and/or video files to their electronic devices from nonvolatile storage (e.g., Flash drives, optical disks, etc.) and/or peer-to-peer connections with one another and review the files with or without network connections to a remote content repository (e.g., content repository 114).

While playback of the content is enabled, interaction apparatus 112 may provide text boxes, buttons, checkboxes, radio buttons, drop-down menus, sliders, and/or other user-interface elements for obtaining input related to the content from the users. Interaction apparatus 112 may also include functionality to accept audio and/or video input through microphones, cameras (e.g., webcams, mobile phone cameras, etc.), and/or other input devices of the electronic device(s). For example, interaction apparatus 112 may obtain the input as text, one or more flags, images (e.g., photos, storyboards, diagrams, etc.), audio recordings (e.g., of speech, music, and/or sound effects), and/or video recordings (e.g., of speech, eye movements, facial expressions, and/or gestures). Interaction apparatus 112 may then store the input along with metadata associated with the input and/or content (e.g., timestamps, user identifiers, content identifiers, etc.) in an input repository 106. If the input is obtained from a user while the user's electronic device lacks a network connection (e.g., while the user is “offline”), the input and/or metadata may be stored locally on the electronic device and subsequently uploaded to input repository 106 after the network connection is restored. Once the input is persisted in input repository 106, interaction apparatus 112 may display the input during subsequent playback of the content, such that a particular piece of input is shown once the playback has arrived at the timestamp at which the input was received.

In one or more embodiments, content-collaboration framework 102 facilitates input from the users during playback of content from content repository 104 by automatically pausing the playback without receiving requests to pause the playback and/or provide the input from the users. As mentioned above, the input may be provided through one or more input devices of the users' electronic devices. For example, a user may initiate the input by typing on a keyboard and/or interacting with a mouse and/or touchpad of a laptop computer on which a video is viewed. Once interaction apparatus 112 detects the selection of an input field (e.g., text box) within which the input is entered and/or the first keystroke on the keyboard, playback-management apparatus 114 may pause playback of the content to allow the user to provide a comment at the relevant point in the video and/or without missing subsequent parts of the video. Alternatively, the user may initiate the input by speaking into a microphone and/or performing a gesture (e.g., using sign language) that is captured by a camera. After the speech and/or gesture are recognized, playback-management apparatus 114 may pause the video to facilitate the capture of subsequent speech and/or gestures from the user without distracting the user and/or capturing sound and/or video from the content along with the speech and/or gestures.

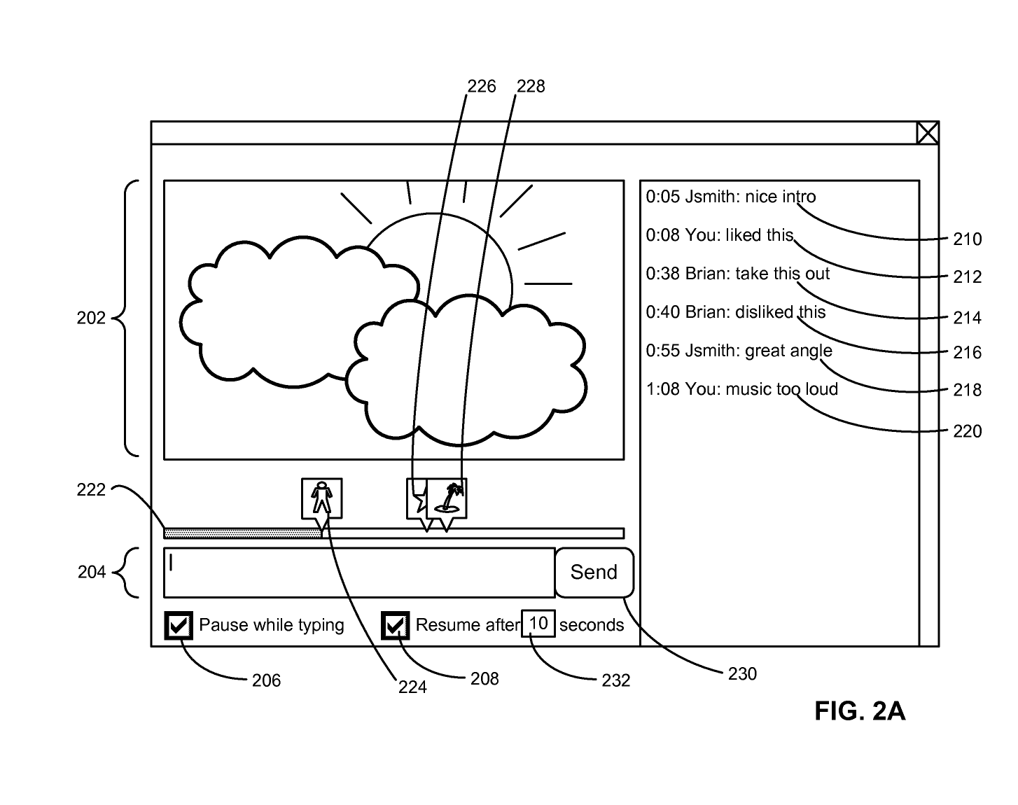

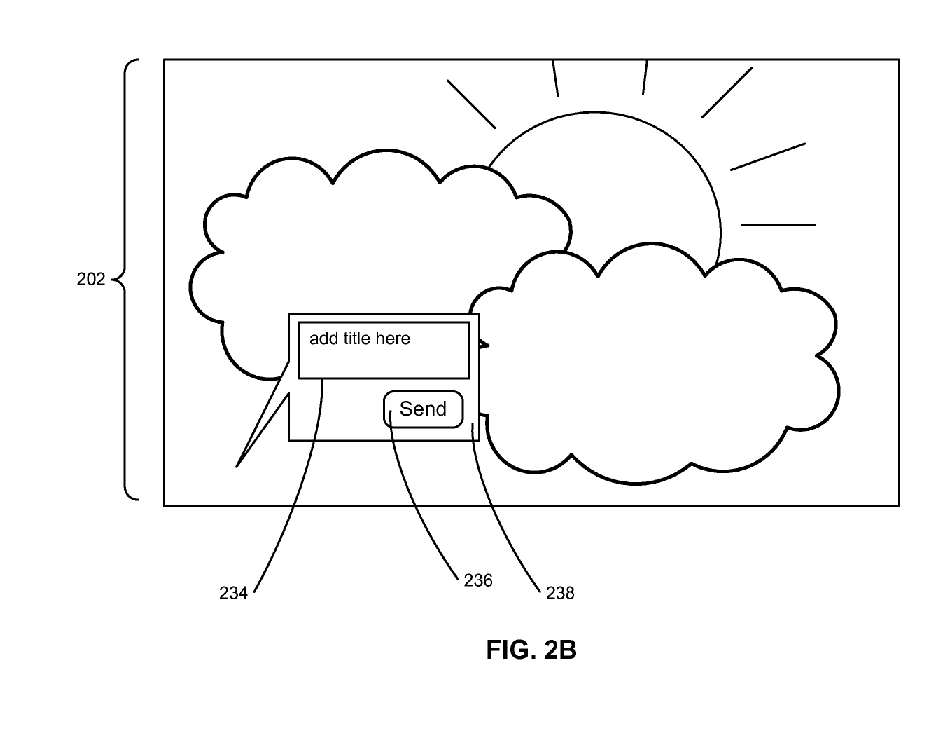

While the user provides the input, interaction apparatus 112 may display the input outside a region of the interface used in playback of the content. For example, interaction apparatus 112 may show text-based input within a text box below a rectangular region from which a video is shown to the user. Alternatively, interaction apparatus 112 may display the input within an overlay associated with the content and/or reposition the overlay based on the input. For example, interaction apparatus 112 may allow the user to provide a text-based comment within a specific frame of a video by displaying a “bubble” containing a text box over the frame. To reposition the “bubble,” the user may drag the “bubble” to a different part of the frame and/or select a point and/or region of the frame corresponding to the comment in the “bubble.” Use of overlays in obtaining input related to content from users is discussed in further detail below with respect to FIG. 2B.

Playback-management apparatus 114 may resume playback of the content after the input is submitted by the user and/or has not been received for a pre-specified period. For example, playback-management apparatus 114 may resume playback of an audio and/or video track after the user has pressed an “enter” key, selected a button for submitting the input, and/or issued a voice command and/or gesture for submitting the input. Playback-management apparatus 114 may also automatically resume playback if the user has not provided keystrokes, speech, gestures, and/or other input for a number of seconds. Any input provided by the user prior to automatic resumption of the playback may be discarded, kept in a buffer for subsequent modification and/or submission by the user, and/or regarded as submitted and stored in input repository 106. Automatic pausing and/or resuming of playback of content based on input from users is discussed in further detail below with respect to FIGS. 2A-2B.

Such automatic pausing and/or resuming of playback may reduce overhead associated with providing input associated with the content during review of the content. In particular, automatic pausing of the playback upon detecting initiation of the input by a user may allow the user to provide the input without manually pausing and/or rewinding the content and/or requesting the ability to provide the input. Along the same lines, resuming of the playback after the input is submitted and/or a pre-specified timeout period of no additional input may allow the user to resume viewing and/or listening to the content without explicitly requesting resumption of the playback and/or submission of the input. In other words, content-collaboration framework 102 may reduce the amount of user interaction, effort, and/or time required to provide and/or share input associated with the content during collaboration on production of the content.

As mentioned above, each user may access the content and/or provide input through a GUI associated with content-collaboration framework 102. Within the GUI, playback-management apparatus 114 may include the progress bar, which represents the user's current progress in viewing and/or listening to the content.

To further facilitate collaboration on and/or sharing of the content among the users, playback-management apparatus 114 may display graphical representations of users currently accessing the content along a progress bar associated with playback of the content. More specifically, playback-management apparatus 114 may display an icon, thumbnail, and/or other graphical representation of the user at a point along the progress bar corresponding to the user's position in the content. If other users are simultaneously participating in playback of the content, playback-management apparatus 114 may also display icons, thumbnails, and/or other graphical representations of the other users at the points along the progress bar corresponding to the other users' positions in the content. In turn, the user and/or other users may have a better sense of each user's progression through the content, thus allowing the users to identify important parts of the content and/or better collaborate on production of the content.

Those skilled in the art will appreciate that the system of FIG. 1 may be implemented in a variety of ways. As mentioned above, interaction apparatus 112 and playback-management apparatus 114 may use various input/output (I/O) mechanisms to enable and manage playback of content to the users and/or obtain input related to the content from the user. In addition, interaction apparatus 112, playback-management apparatus 114, content repository 104, and input repository 106 may be provided by various components and/or devices. For example, interaction apparatus 112 and playback-management apparatus 114 may execute within the same hardware and/or software component (e.g., processor, computer system, mobile phone, tablet computer, electronic device, server, grid, cluster, cloud computing system, application, process, etc.), or interaction apparatus 112 and playback-management apparatus 114 may execute independently of one another. Similarly, content repository 104 and input repository 106 may be provided by the same relational database, filesystem, and/or storage mechanism, or content repository 104 and input repository 106 may reside on separate databases, filesystems, and/or storage mechanisms.

FIG. 2A shows an exemplary screenshot in accordance with one or more embodiments. More specifically, FIG. 2A shows a screenshot of a user interface for a content-collaboration framework, such as content-collaboration framework 102 of FIG. 1. Within the user interface, a user may view content 202 such as streaming audio and/or video. The user may also use buttons, keyboard shortcuts, sliders, and/or other input mechanisms associated with the user interface to pause, resume, stop, rewind, fast-forward, skip, and/or slow playback of content 202.

During playback of content 202, a progress bar 222 may indicate the progress of the user through content 202. In addition, the user interface may include a graphical representation 224 of the user at the user's current point in content 202, as well as graphical representations 226-228 of other users currently accessing content 202 at the other users' respective points in content 202. For example, graphical representations 226-228 may include icons, thumbnails, pictures, and/or other graphical objects selected by and/or associated with the users. Graphical representations 224-228 may facilitate collaboration on production of the content by the users by allowing the users to have a sense of one another's progress through content 202 and/or coordinate viewing of content 202 with one another. For example, the user may use graphical representations 224-228 to determine how many other users are concurrently accessing content 202 and/or how quickly the other users are moving through content 202.

The user interface may also include an input field 204 for obtaining input related to content 202 from the user. For example, input field 204 may be a text box that accepts text-based comments and/or feedback from the user. After the user has provided the input, the user may submit the input by pressing an “enter” key and/or selecting a button 230 (e.g., “Send”) in the user interface. The user interface may additionally accept other types of input from the user through other input mechanisms. For example, the user interface may provide buttons and/or keyboard shortcuts that allow the user to like, dislike, rate, and/or otherwise flag a particular point in content 202. Along the same lines, the user interface may accept audio and/or visual input (e.g., speech, gestures, eye movements, facial expressions, etc.) from the user through speakers, microphones, and/or other input devices available to the user.

The user interface may further display a set of input 210-220 submitted by the user and/or other users for review by the user and/or other users. As shown in FIG. 2A, each piece of input 210-220 may include a timestamp in the video at which the input was received, a user providing the input, and/or a comment representing the input. For example, input 210 may have a timestamp of “0:05,” a user of “Jsmith,” and a comment of “nice intro.” Input 212 may have a timestamp of “0:08,” a user of “You,” and a comment of “liked this.” Input 214 may have a timestamp of “0:38,” a user of “Brian,” and a comment of “take this out.” Input 216 may have a timestamp of “0:40,” a user of “Brian,” and a comment of “disliked this.” Input 218 may have a timestamp of “0:55,” a user of “Jsmith,” and a comment of “great angle.” Finally, input 220 may have a timestamp of “1:08,” a user of “You,” and a comment of “music too loud.” As the user progresses through playback of content 202, input at or before the user's current point in the playback may be added to the region of the user interface containing input 210-220.

As described above, playback of content 202 may automatically be paused upon detecting initiation of input by the user. For example, the playback may be paused if the user selects input field 204 using a cursor and/or keyboard shortcut and/or begins typing on a keyboard and/or virtual keyboard, with or without selecting input field 204. The playback may also be paused if the user begins speaking into a microphone and/or performing specific gestures, facial expressions, and/or eye movements in front of a camera. Such automatic pausing of playback may be enabled or disabled by the user through a checkbox 206 (e.g., “Pause while typing”) in the user interface.

Similarly, playback may automatically resume after the user submits the input and/or if the input has not been received for a pre-specified period. For example, playback of content 202 may continue after the user has pressed an “enter” key and/or button 230 during providing of input, or if the user has not provided input for more than 10 seconds. The user may enable or disable such automatic resumption of playback through a checkbox 208 (e.g., “Resume after 10 seconds”) and control the pre-specified period before playback automatically resumes through a text box, drop-down menu, and/or other user-interface element 232. If both checkboxes 206-208 are selected, the user may provide input while content 202 is paused without explicitly requesting the pausing of content 202, the providing of input, and/or the resuming of content 202 to the user interface, thus streamlining both reviewing of content 202 and providing of input related to content 202 for the user.

FIG. 2B shows an exemplary screenshot in accordance with one or more embodiments. As with the screenshot of FIG. 2A, FIG. 2B shows a screenshot of a user interface for a content-collaboration framework, such as content-collaboration framework 102 of FIG. 1. Unlike the screenshot of FIG. 2A, FIG. 2B may show the user interface while content 202 is shown in “full-screen” mode. As a result, many user-interface elements shown within the user interface of FIG. 2A may be omitted from the user interface of FIG. 2B.

On the other hand, FIG. 2B includes an overlay 238 associated with content 202, which may be used by the user to provide input related to content 202. For example, the user may provide a comment (e.g., “add title here”) related to content 202 using an input field 234 provided by overlay 238. To activate the display of overlay 238 within the user interface, the user may enter a keyboard shortcut and/or simply begin typing the comment. The user may also initiate input of the comment by speaking into a microphone associated with an electronic device (e.g., mobile phone, tablet computer, personal computer, laptop computer, portable media player, etc.) providing the user interface. In turn, the electronic device may use a speech-recognition technique to convert the user's speech into a text-based comment and/or store a recording of the user's speech for subsequent playback during collaboration on production of content 202. The user may also reposition overlay 238 within a frame of content 202 by dragging overlay 238 within the frame and/or using a cursor to select a point and/or region within the frame.

Once the user initiates the input, playback of content 202 may automatically be paused to allow the user to provide the input and/or adjust the position of overlay 238 without missing subsequent playback of content 202. The playback may then resume after the user submits the input by pressing an “enter” key and/or selecting a button 236 (e.g., “Send”). The playback may also resume without the user explicitly submitting the input if the user does not provide additional input after a pre-specified period (e.g., a number of seconds).

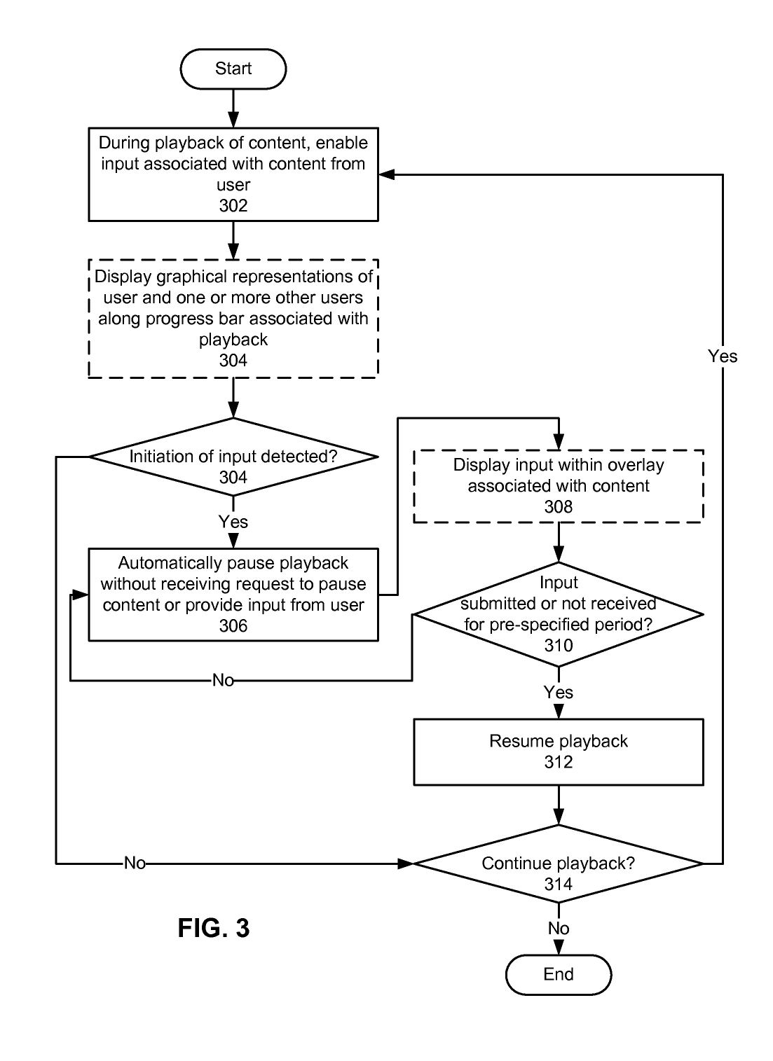

FIG. 3 shows a flowchart illustrating the process of providing content to a user in accordance with one or more embodiments. In one or more embodiments, one or more of the steps may be omitted, repeated, and/or performed in a different order. Accordingly, the specific arrangement of steps shown in FIG. 3 should not be construed as limiting the scope of the embodiments.

During playback of the content, input associated with the content from the user is enabled (operation 302). The content may include audio, video, and/or other time-based and/or sequential content. In addition, graphical representations of the user and one or more other users may optionally be displayed along a progress bar associated with the playback (operation 304). The graphical representations may allow the user to identify other users concurrently accessing the content, along with the other users' progress through the content.

Initiation of input by the user may also be detected (operation 304). For example, the user may initiate the input by selecting an input field associated with the input, using an input device, and/or providing audio input, a gesture, a facial expression, and/or an eye movement. If initiation of input is not detected, playback of the content may continue (operation 314) until the playback is disabled.

If initiation of input is detected, the playback is automatically paused without receiving a request to pause the content or provide the input from the user (operation 306). Such automatic pausing may reduce the amount of time, effort, and/or interaction required by the user to provide the input while reviewing the content. Furthermore, the input may optionally be displayed within an overlay associated with the content (operation 308) during providing of the input by the user. For example, the overlay be shown on top of a frame of the content and include text-based and/or graphical input provided by the user. The overlay may also be repositioned based on dragging of the overlay, selection of a point and/or region in the frame, and/or other input from the user.

The input may be submitted, or the input may not be received by the user for a pre-specified period (operation 310). If the input continues to be received before the pre-specified period has passed and/or is not submitted, the playback may continue to be paused (operation 306), with optional display of the input within the overlay (operation 308). Once the input is submitted and/or the pre-specified period has passed without receiving additional input, the playback is resumed (operation 312).

Playback of the content may continue (operation 314) during review of the content and/or providing of input associated with the content by the user. If playback is to continue, the input is enabled (operation 302), and graphical representations of the user and the other user(s) are optionally displayed along the progress bar (operation 304). Input associated with the content may also be used to automatically pause and/or resume playback of the content (operations 304-312). Such management of input and/or playback associated with the content may continue until the user is no longer reviewing the content and/or playback of the content is disabled.

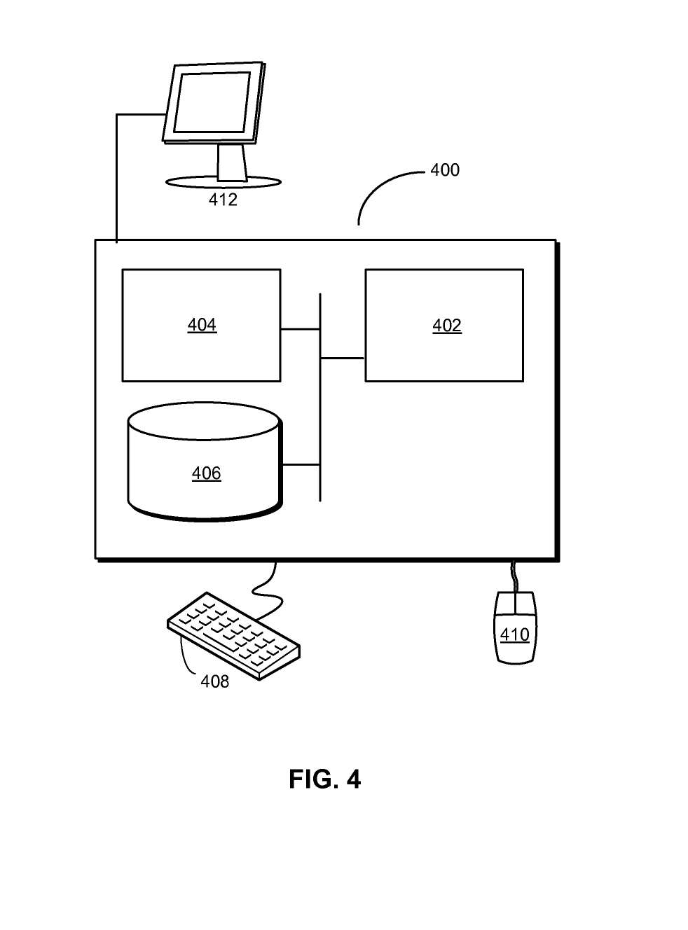

FIG. 4 shows a computer system 400 in accordance with one or more embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include I/O devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for providing content to a user. The system may include an interaction apparatus that enables input associated with the content from the user during playback of the content and detects initiation of the input by the user. The interaction apparatus may also display the input within an overlay associated with the content while the user provides the input.

The system may also include a playback-management apparatus. After initiation of the input by the user is detected, the playback-management apparatus may automatically pause the playback without receiving a request to pause the content or provide the input from the user. Next, the playback-management apparatus may resume the playback after the input has not been received for a pre-specified period and/or if the input is submitted by the user. Finally, the playback-management apparatus may display graphical representations of the user and one or more other users along a progress bar associated with the playback.

In addition, one or more components of computer system 400 may be remotely located and connected to the other components over a network. Portions of the present embodiments (e.g., interaction apparatus, playback-management apparatus, etc.) may also be located on different nodes of a distributed system that implements the embodiments. For example, the present embodiments may be implemented using a cloud computing system that enables playback of content on a set of remote electronic devices and obtains input from users of the electronic devices during the playback.

Although the disclosed embodiments have been described with respect to a limited number of embodiments, those skilled in the art, having benefit of this disclosure, will appreciate that many modifications and changes may be made without departing from the spirit and scope of the disclosed embodiments. Accordingly, the above disclosure is to be regarded in an illustrative rather than a restrictive sense. The scope of the embodiments is defined by the appended claims.

What is claimed is:

1. A computer-implemented method for providing content to a user, comprising:
during playback of the content, enabling input associated with the content from the user; and
upon detecting initiation of the input by the user, automatically pausing the playback without receiving a request to pause the content or provide the input from the user.

2. The computer-implemented method of claim 1, further comprising:
automatically resuming the playback after the input has not been received for a pre-specified period.

3. The computer-implemented method of claim 1, further comprising:
resuming the playback after the input is submitted by the user.

4. The computer-implemented method of claim 1, further comprising:
during providing of the input by the user, displaying the input within an overlay associated with the content.

5. The computer-implemented method of claim 4, wherein displaying the input as the overlay associated with the content comprises:
repositioning the overlay based on the input.

6. The computer-implemented method of claim 1, further comprising:
displaying graphical representations of the user and one or more other users along a progress bar associated with the playback.

7. The computer-implemented method of claim 1, wherein the input comprises at least one of:
selection of an input field associated with the input;
use of an input device;
audio input;
a gesture;
a facial expression; and
an eye movement.

8. A system for providing content to a user, comprising:
an interaction apparatus configured to:
enable input associated with the content from the user during playback of the content; and
detect initiation of the input by the user; and
a playback-management apparatus, wherein after initiation of the input by the user is detected, the playback-management apparatus is configured to automatically pause the playback without receiving a request to pause the content or provide the input from the user.

9. The system of claim 8, wherein the playback-management apparatus is further configured to:
automatically resume the playback after the input has not been received for a pre-specified period.

10. The system of claim 8, wherein the playback-management apparatus is further configured to:
resume the playback after the input is submitted by the user.

11. The system of claim 8, wherein the interaction apparatus is further configured to:
display the input within an overlay associated with the content during providing of the input by the user.

12. The system of claim 11, wherein displaying the input as the overlay associated with the content comprises:
repositioning the overlay based on the input.

13. The system of claim 8, wherein the playback-management apparatus is further configured to:
display graphical representations of the user and one or more other users along a progress bar associated with the playback.

14. The system of claim 8, wherein the input comprises at least one of:
selection of an input field associated with the input;
use of an input device;
audio input;
a gesture;
a facial expression; and
an eye movement.

15. A non-transitory computer-readable storage medium containing instructions embodied therein for causing a computer system to perform a method for providing content to a user, comprising:
during playback of the content, enabling input associated with the content from the user; and
upon detecting initiation of the input by the user, automatically pausing the playback without receiving a request to pause the content or provide the input from the user.

16. The non-transitory computer-readable storage medium of claim 15, the method further comprising:
automatically resuming the playback after the input has not been received for a pre-specified period.

17. The non-transitory computer-readable storage medium of claim 15, the method further comprising:
resuming the playback after the input is submitted by the user.

18. The non-transitory computer-readable storage medium of claim 15, the method further comprising:
during providing of the input by the user, displaying the input within an overlay associated with the content.

19. The non-transitory computer-readable storage medium of claim 18, wherein displaying the input as the overlay associated with the content comprises:
repositioning the overlay based on the input.

20. The non-transitory computer-readable storage medium of claim 15, the method further comprising:
displaying graphical representations of the user and one or more other users along a progress bar associated with the playback.
